(19) United States
(12) Patent Application Publication
(10) Pub. No.: US 2019/0092227 A1
(43) Pub. Date: Mar. 28, 2019

(54) ANALOG GAUGE WITH WIRELESS ILLUMINATION

(71) Applicants: SYLVAIN DENISE, CERGY (FR); FABRICE RAZAFINDRABEZA, CERGY (FR); GEORGES PRIGENT, CERGY (FR); YAHIA HAMMICHE, ARGENTEUIL (FR); JEAN LUC CROY, CERGY (FR)

(72) Inventors: SYLVAIN DENISE, CERGY (FR); FABRICE RAZAFINDRABEZA, CERGY (FR); GEORGES PRIGENT, CERGY (FR); YAHIA HAMMICHE, ARGENTEUIL (FR); JEAN LUC CROY, CERGY (FR)

(21) Appl. No.: 15/712,948

(22) Filed: Sep. 22, 2017

(51) Int. Cl. B60Q 3/16; B60Q 3/14; B60Q 3/12; G07C 5/00; G07C 5/08; H01F 38/14; B60K 37/02

(52) U.S. Cl. CPC B60Q 3/16; B60Q 3/14; B60Q 3/12; G07C 5/008; B60K 35/00; H01F 38/14; B60K 37/02; B60K 2350/357; B60K 2350/408; G07C 5/0825

(57) ABSTRACT

An analog gauge includes a pointer attached to a post and overlying and rotating relative to a substrate to indicate a first vehicle operating condition. A cap may be disposed on the pointer and opposite the substrate and over the post, with a first coil of electrically conductive material disposed therein. A light source may be mounted to the pointer and in electrical communication with the first coil. A second coil of electrically conductive material may provide power to the first coil via non-contact coupling. A stepper motor may cause the pointer to rotate. The second coil may be formed as a trace in a metal layer of a printed circuit board disposed beneath the substrate. The light source may cause the pointer to be illuminated. Alternatively, the light source may cause an applique in the cap to illuminate as a telltale icon, indicating a second vehicle operating condition.

### BACKGROUND

Analog gauges are commonly provided in instrument clusters of motor vehicles to indicate various vehicle operating conditions. Analog gauges are frequently used, for example, as speedometers, tachometers, and fuel gauges. Such analog gauges are also commonly equipped with illumination means to allow the gauge to be easily visible in low ambient light conditions, such as for nighttime operation. Analog gauges may include a pointer that rotates about a post and relative to a substrate, which may include indicia such as a hash marks and/or numbers. Analog gauges may be provided with a cap that overlies the post and which may provide an attractive appearance. Many different means are provided in the art for allowing analog gauges to be illuminated, such as through indirect lighting which may be provided, for example, by lightpipes. Light sources may be provided directly on a pointer, however complex means for conveying electrical energy to such a light source may be required and which can withstand frequent motion of the pointer as well as the harsh conditions inherent in vehicular applications such as vibration and extreme temperatures.

Telltale indicators are also commonly provided in instrument clusters of motor vehicles to indicate vehicle operating conditions such as a low fuel or a fault condition with a specific component such as with a “check engine” light. Modern instrument clusters may be crowded with numerous such telltale indicators which may not be easily apparent to the driver.

Therefore, there exists a need for an inexpensive and reliable means of transmitting power to a light source on a pointer of an analog gauge which is not adversely affected by the motion of the pointer. There also exists a need for a simplified presentation of telltale indicators in a way that is easily visible and apparent to the driver of the vehicle.

### SUMMARY

An analog gauge for use in a vehicle installment panel is disclosed which includes a pointer overlying a substrate to rotate and to indicate a vehicle operating condition. The pointer may include a cap disposed opposite the substrate, and a light source mounted to the pointer. A first coil of electrically conductive material may be disposed within the cap of the pointer and in electrical communication with the light source. A second coil of electrically conductive material may provide power to the first coil via non-contact coupling to cause the light source to be illuminated.

The placement of the first coil within the cap of the pointer may provide several advantages over illumination devices for analog gauges known from the prior art. The cap may be over molded with the coil embedded therein, allowing easy final assembly of the pointer and easy connection to the light source. The cap with the coil and the light source may be manufactured an integral unit, which may be sealed at the time of manufacturing.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a schematic diagram of an analog gauge with a light source powered by a non-contact coupling;

FIG. 2 is a cut-away side view of an embodiment of an analog gauge;

FIG. 3 is a cut-away side view of another embodiment of an analog gauge;

FIG. 4 is a top view of a printed circuit board; and

FIG. 5 is a perspective view of traces on two layers of a printed circuit board.

### DESCRIPTION

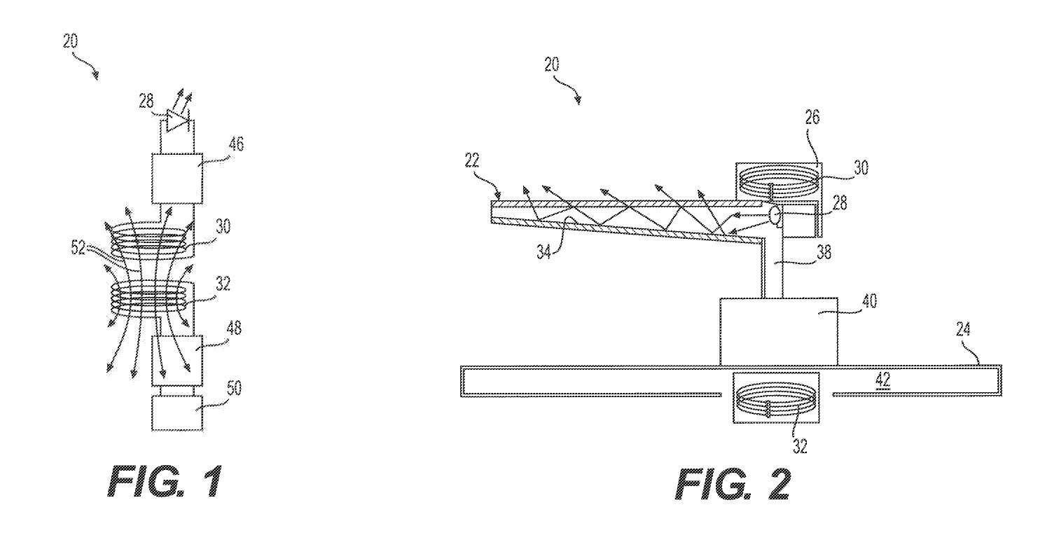

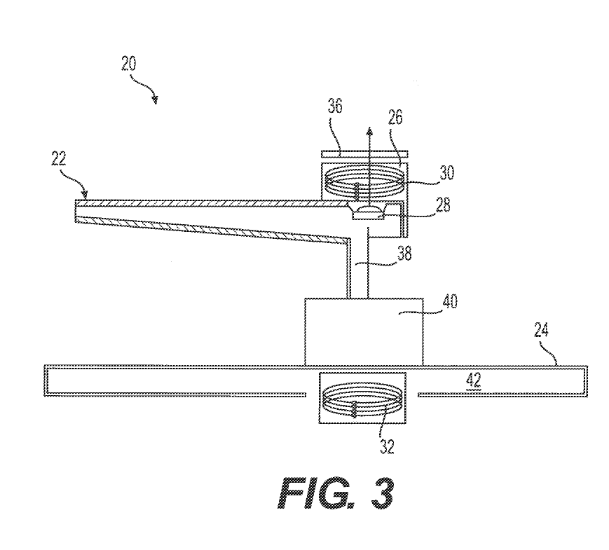

An analog gauge 20 for use in a vehicle instrument panel is disclosed which may include a pointer 22 overlying a substrate 24 to rotate and to indicate a first vehicle operating condition. The pointer 22 may extend radially outwardly from a post 38 and may rotate thereabout. The substrate 24 may include, for example, gauge markings such as numbers and/or hash marks to indicate a numeric value or a relative amount of some quantity related to the first vehicle operating condition. Such an analog gauge 20 may be used for example, as a speedometer, tachometer, or as a fuel or temperature gauge. As shown in FIGS. 2-3, the pointer 22 may include a cap 26 disposed opposite the substrate 24 and which may overlie the post 38. The cap 26 may function to secure the pointer 22 onto the post 38 and may also provide other functional and aesthetic functions as are described below.

As shown in FIGS. 2-3, the analog gauge 20 may include a light source 28, which may be, for example, an LED mounted to the pointer 22. Other types of electrically powered light sources 28 may also be used such as, for example, incandescent bulbs, OLED, fluorescent gas, etc. A first coil 30 of electrically conductive material may be disposed within the cap 26 of the pointer 22 and in electrical communication with the light source 28 to cause the light source 28 to be powered by non-contact coupling. A second coil 32 of electrically conductive material may provide power to the first coil 30 via the non-contact coupling. In other words, the light source 28 may be electrically isolated from the electrical system of the vehicle, but may be powered by a non-contact coupling such as by magnetic coupling which may cause a voltage to be induced in the first coil 30. The second coil 32, which may be in electrical communication with one or more electrical devices or systems in the vehicle, may provide the power to the first coil 30. One or both of the coils 30, 32 may be formed from electrical wire, such as copper which may be coated with a nonconductive coating. The analog gauge 20 may include a stepper motor 40 to the pointer 22 to rotate relative to the substrate 24. Other means may be used to cause the pointer to rotate, such other means may include, for example, one or more a magnetic coils, brushed or brushless electric motor, and/or a mechanical coupling such as a speedometer cable, etc.

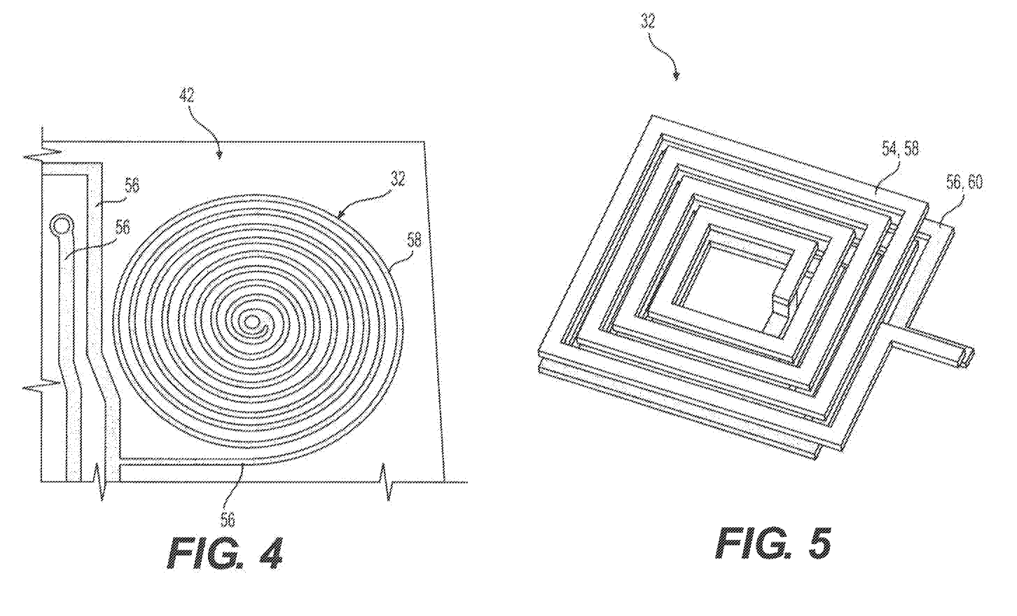

According to an aspect, a printed circuit board 42 disposed beneath the substrate 24 opposite the pointer 22 may include a first metal layer defining a plurality of first traces 54 of electrically conductive material, which may, for example, function to control operational characteristics of the pointer 22 and/or the light source 28. The printed circuit board 42 may also include a second metal layer extending parallel to the first metal layer and separated therefrom by non-conductive material and defining a plurality of second traces 56 of electrically conductive material. As shown in FIG. 4, the first trace 54 of the printed circuit board 42 may define a first spiral 58 which may form the second coil 32. According to a further aspect, and as illustrated in FIG. 5, the second trace 56 of the printed circuit board 42 may define a second spiral 60 aligned with the first spiral 58, with the spirals 58. 60 functioning together as the second coil 32. The printed circuit board 42 may include three or more different layers which may function together as the second coil 32. Increasing the number of metal layers used to form the second coil 32 may increase the magnetic field strength that is able to be generated, which may increase the amount of power that is able to be transferred to the first coil 30.

The spirals 58, 60 may be provided as different shapes including circles or squares as shown in FIGS. 4-5. The spirals 58, 60 may also be formed as a different regular or irregular polygon, such as, for example, as a hexagon or an octagon. By integrally forming the second coil 32 with the printed circuit board 42, a discrete part does not need to be used as the second coil 32. This may provide both a cost savings and a saving in labor and assembly time when compared to an analog gauge using coiled wire as the second coil 32.

According to an aspect, and as shown schematically in FIG. 1, the analog gauge may include a receiver circuit 46 in electrical communication with the first coil 30 to provide electrical power to the light source 28. A transmitter circuit 48 may be provided in electrical communication with the second coil 32 to receive electrical power from a power source 50 and to cause the second coil 32 to provide the non-contact coupling with the first coil 30. The second coil 32 may induce a magnetic field, as represented by a plurality of magnetic field lines 52, to extend through the first coil 30 to induce a voltage therein and to thereby provide the non-contact coupling therebetween. The receiver circuit 46 and the transmitter circuit 48 and the receiver circuit may function together such as, for example, to produce an alternating current in the respective coils, which may be configured to operate over a range of frequencies or only at one or more specific frequencies. The receiver circuit 46 may rectify such alternating current to produce a DC voltage and to limit the voltage produced to a predetermined value which may be chosen to prevent the light source 28 from being damaged by an overvoltage condition.

According to an aspect as illustrated in FIG. 2, the light source 28 may be configured to cause the pointer 22 to be illuminated. A reflective layer 34 may be provided on the pointer 22 to distribute light from the light source 28 along the length of the pointer 22, which may allow a uniform illumination along the length of the pointer 22.

According to another aspect, and as illustrated in FIG. 3, the analog gauge 20 may include an applique 36 on the cap 26 of the pointer 22 extending generally parallel to the substrate 24 and having at least a portion thereof being translucent or transparent and another portion thereof being opaque to define a predetermined pattern. In this way, the light source 28 may cause the applique 36 to illuminate the predetermined pattern to indicate a second vehicle operating condition. Such an illuminated applique may function as a telltale light which may indicate a fault or warning condition. The telltale light may, but is not necessarily, related to the first vehicle operating condition. For example, an analog gauge 20 configured as a fuel gauge may be provided with an applique 36 on the cap 26 of the pointer 22 with an icon corresponding to a low-fuel warning light. An analog gauge 20 configured as a speedometer may include a an applique 36 on the cap 26 with an icon corresponding to an engine malfunction, which is not related to the first vehicle operating condition of speed, but which may warrant a high-visibility position on the speedometer where the driver's attention is frequently directed.

Obviously, many modifications and variations of the present invention are possible in light of the above teachings and may be practiced otherwise than as specifically described while within the scope of the appended claims.

What is claimed is:

1. An analog gauge for use in a vehicle instrument panel comprising:
a pointer overlying a substrate to rotate indicating a first vehicle operating condition;
said pointer including a cap disposed opposite said substrate;
a light source mounted to said pointer;
a first coil of electrically conductive material disposed within said cap of said pointer and in electrical communication with said light source; and
a second coil of electrically conductive material providing power to said first coil via non-contact coupling to cause said light source to be illuminated.

2. The analog gauge for use in a vehicle instrument panel as set forth in claim 1 further including a reflective layer on said pointer; and
wherein said light source causes said pointer to be illuminated.

3. The analog gauge for use in a vehicle instrument panel as set forth in claim 1 further including an applique on said cap of said pointer extending generally parallel to said substrate and having at least a portion thereof being translucent; and
wherein said light source causes said applique to be illuminated.

4. The analog gauge for use in a vehicle instrument panel as set forth in claim 1 wherein said pointer extends radially outwardly from a post and rotates thereabout to indicate the first vehicle operating condition.

5. The analog gauge for use in a vehicle instrument panel as set forth in claim 1 further including a motor for causing said pointer to rotate relative to said substrate.

6. The analog gauge for use in a vehicle instrument panel as set forth in claim 5 wherein said motor is a stepper motor.

7. The analog gauge for use in a vehicle instrument panel as set forth in claim 1 wherein said light source includes one or more light emitting diodes (LEDs).

8. The analog gauge for use in a vehicle instrument panel as set forth in claim 1 further including a printed circuit board disposed beneath said substrate opposite said pointer.

9. The analog gauge for use in a vehicle instrument panel as set forth in claim 8 wherein said printed circuit board includes a first metal layer defining a plurality of first traces of electrically conductive material for controlling operational characteristics of said pointer and said light source.

10. The analog gauge for use in a vehicle instrument panel as set forth in claim 9 wherein said second coil is formed from one or more of said first traces on said printed circuit hoard.

11. The analog gauge for use in a vehicle instrument panel as set forth in claim 10 wherein said first traces of said printed circuit hoard define a first spiral to form said second coil.

12. The analog gauge for use in a vehicle instrument panel as set forth in claim 11 wherein said printed circuit board further includes a second metal layer extending parallel to said first metal layer and separated therefrom by non-conductive material and defines a second trace of electrically conductive material and defining a second spiral aligned with said first spiral; and
wherein said second coil includes said first spiral and said second spiral.

13. The analog gauge for use in a vehicle instrument panel as set forth in claim 1 further including a receiver circuit in electrical communication with said first coil to provide electrical power to said light source;

14. The analog gauge for use in a vehicle instrument panel as set forth in claim 1 further including a transmitter circuit in electrical communication with said second coil to receive electrical power from a power source and to cause said second coil to provide the non-contact coupling with said first coil.

15. The analog gauge for use in a vehicle instrument panel as set forth in claim 1 wherein second coil said causes a plurality of magnetic field lines to extend through said first coil to induce a voltage therein and to thereby provide said non-contact coupling therebetween.

16. An analog gauge for use in a vehicle instrument panel comprising:
a pointer overlying a substrate to rotate indicating a first vehicle operating condition;
said pointer including a cap disposed opposite said substrate;
a light source mounted to said pointer;
a first coil of electrically conductive material disposed within said cap of said pointer and in electrical communication with said light source; and
an applique on said cap of said pointer extending generally parallel to said substrate and having at least a portion thereof being translucent or transparent and another portion thereof being opaque to define a predetermined pattern; and
wherein said light source causes said applique to illuminate the predetermined pattern to indicate a second vehicle operating condition.

17. An analog gauge for use in a vehicle instrument panel comprising:
a pointer extending radially outwardly from a post and overlying a substrate to rotate about said post to indicate a first vehicle operating condition;
said pointer including a cap disposed opposite said substrate;
a light source including an LED mounted to said pointer;
a first coil of electrically conductive material disposed within said cap of said pointer and in electrical communication with said light source to cause said light source to be powered by non-contact coupling;
a second coil of electrically conductive material providing power to said first coil via the non-contact coupling;
a printed circuit hoard disposed beneath said substrate opposite said pointer and including a first metal layer defining a plurality of first traces of electrically conductive material for controlling operational characteristics of said pointer and said light source;
said printed circuit board including a second metal layer extending parallel to said first metal layer and separated therefrom by non-conductive material and defining a plurality of second traces of electrically conductive material;
said first trace of said printed circuit board defining a first spiral to form said second coil;
said second trace of said printed circuit board defining a second spiral aligned with said first spiral to form said second coil;
a stepper motor for causing said pointer to rotate relative to said substrate;
a receiver circuit in electrical communication with said first coil to provide electrical power to said light source;
a transmitter circuit in electrical communication with said second coil to receive electrical power from a power source and to cause said second coil to provide the non-contact coupling with said first coil; and
wherein said second coil causes a plurality of magnetic field lines to extend through said first coil to induce a voltage therein and to thereby provide said non-contact coupling therebetween.

18. The analog gauge for use in a vehicle instrument panel as set forth in claim 17 further including a reflective layer on said pointer; and
wherein said light source causes said pointer to be illuminated.

19. The analog gauge for use in a vehicle instrument panel as set forth in claim 17 further including an applique on said cap of said pointer extending generally parallel to said substrate and having at least a portion thereof being translucent or transparent and another portion thereof being opaque to define a predetermined pattern; and
wherein said light source causes said applique to illuminate the predetermined pattern to indicate a second vehicle operating condition.
